(19) United States
(12) Patent Application Publication
(10) Pub. No.: US 2025/0201939 A1
(43) Pub. Date: Jun. 19, 2025

(54) BATTERY THERMAL PROPAGATION

(71) Applicant: Caterpillar Inc., Peoria, IL (US)

(72) Inventors: Bala Vinaya KESANAKURTHY, Dunlap, IL (US); Ted Gerhardt RIMSTIDT, West Lafayette, IN (US)

(73) Assignee: Caterpillar Inc., Peoria, IL (US)

(21) Appl. No.: 18/540,766

(22) Filed: Dec. 14, 2023

(51) Int. Cl. H01M 10/42; H01M 10/48; H01M 10/633; H01M 10/635

(52) U.S. Cl. CPC H01M 10/425; H01M 10/482; H01M 10/486; H01M 10/633; H01M 10/635; H01M 2010/4271

(57) ABSTRACT

In some implementations, a battery management system may determine a first temperature associated with a first battery cell. The battery management system may determine a second temperature associated with a second battery cell. The battery management system may receive a thermal model from a remote computing device. The battery management system may determine thermal propagation between the first battery cell and the second battery cell in accordance with the thermal model.

### TECHNICAL FIELD

The present disclosure relates generally to battery thermal propagation and, for example, to a thermal model for predicting thermal propagation for a battery.

### BACKGROUND

A battery management system (BMS) monitors and manages the electrical state, health, and functionality of a battery pack, which typically includes multiple individual battery cells. A BMS may regulate charging and discharging processes, balance the charge across cells, and protect the battery from operating outside operating parameters. The BMS may continuously monitor parameters such as voltage, current, and temperature of each cell, as well as the temperature of the overall battery pack. By doing so, the BMS may prevent conditions that could lead to reduced battery life, inefficiencies, overcharging, deep discharging, overheating, or short-circuiting.

The BMS may seek to prevent a thermal runaway event. A thermal runaway is a self-sustaining, exothermic reaction that can occur within a battery cell, leading to a rapid increase in temperature and potential cell failure. A thermal runaway typically initiates when a battery is subjected to conditions like overcharging, short-circuiting, physical damage, or external heat, which cause an increase in the internal temperature of the cell. This temperature rise can lead to the breakdown of internal battery materials and the generation of heat, further accelerating the temperature increase. If left unchecked, thermal runaway can result in the degradation of the battery's electrolyte and other components, potentially leading to failure. The susceptibility of a battery to thermal runaway is influenced by its chemistry, design, and state of health. Predicting thermal runaway events can be challenging because of the complexity of the factors that may result in a thermal runaway.

U.S. Pat. No. 11,314,305 (the '305 patent) discloses a thermal reduced order model (ROM) that is trained through machine learning to provide efficient systems that can significantly reduce the time and computational resources required to build a simulation of a device's thermal behavior. The thermal model can be used in different usage scenarios with different power management and thermal management controls to test the device's thermal behavior. While the ROM of the '305 patent can be used to simulate thermal behavior, it cannot simulate thermal propagation across different components of a battery pack.

The BMS of the present disclosure solves one or more of the problems set forth above and/or other problems in the art.

### SUMMARY

A battery management system may include one or more memories; and one or more processors, communicatively coupled to the one or more memories, configured to: receive a thermal model in accordance with a first temperature associated with a first battery cell and a second temperature associated with a second battery cell; and determine thermal propagation between the first battery cell and the second battery cell in accordance with the thermal model.

A method may include determining a first temperature associated with a first battery cell; determining a second temperature associated with a second battery cell; receiving a thermal model from a remote computing device; determining thermal propagation between the first battery cell and the second battery cell in accordance with the thermal model.

A machine may include a battery module having a plurality of battery cells including a first battery cell and a second battery cell; and a battery management system configured to: receive a thermal model; and determine thermal propagation between the first battery cell and the second battery cell in accordance with the thermal model.

### BRIEF DESCRIPTION OF THE DRAWINGS

FIG. 1 is a diagram of an example battery pack.

FIG. 2 is a diagram of an example implementation associated with a battery management system (BMS) for determining thermal propagation across components of a battery.

FIG. 3 is a flowchart of an example process associated with determining thermal propagation across components of the battery.

### DETAILED DESCRIPTION

This disclosure relates to battery thermal propagation, which is applicable to a battery module that provides power to a machine, such as a machine that performs an operation associated with an industry, such as mining, construction, farming, transportation, or any other industry. For example, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples. As used herein, “battery cell,” “battery,” and “cell” may be used interchangeably.

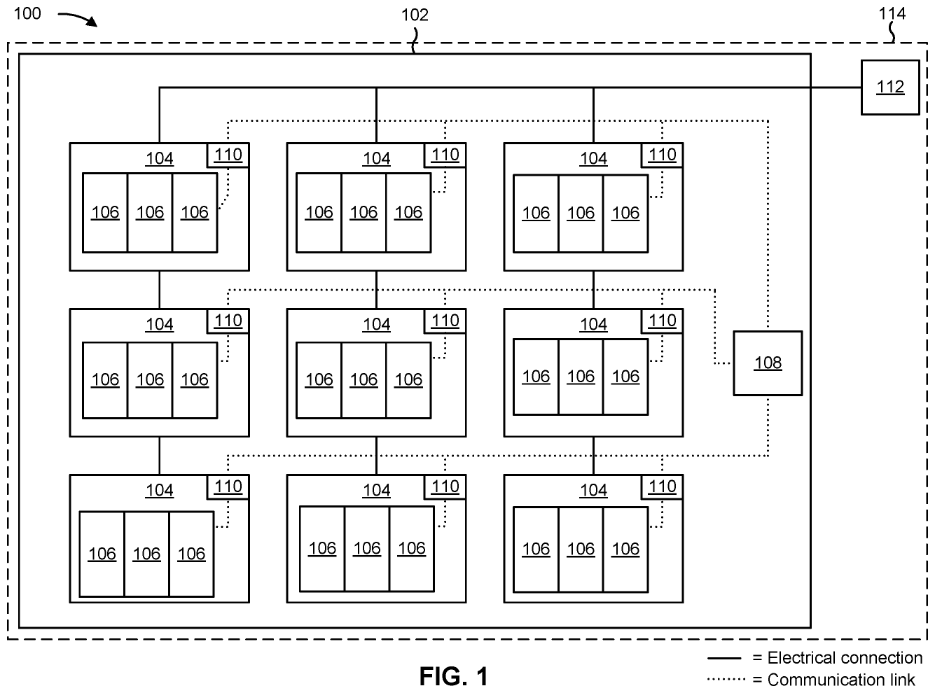

FIG. 1 is a diagram of an example battery pack 100. The battery pack 100 may include a battery pack housing 102, one or more battery modules 104, and one or more battery cells 106. The battery pack 100 includes a battery pack controller 108 (also called a “battery management system (BMS)”) associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as an electric motor, among other examples. As another example, the component 112 provides energy to the battery pack 100 (e.g., to be stored by the battery cells 106). In such examples, the component 112 may be a power generator, a solar energy system, and/or a wind energy system, among other examples. A machine 114 may include the battery pack 100 and the component 112 (e.g., an electric motor). For example, the battery pack 100 (e.g., one or more battery modules 104 thereof) may be electrically connected to the component 112. The machine 114 may be an electric vehicle (e.g., a car, a train, or a boat) or an electric work machine.

The battery pack housing 102 may include metal shielding (e.g., steel, aluminum, or the like) to protect elements (e.g., battery modules 104, battery cells 106, the battery pack controller 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-busbar welds). Each battery cell 106 is associated with a chemistry type. The chemistry type may include lithium ion (Li-ion), nickel-metal hydride (NiMH), nickel cadmium (NiCd), lithium ion polymer (Li-ion polymer), lithium iron phosphate (LFP), and/or nickel manganese cobalt (NMC), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery cells 106 included in each battery module 104, and the number of battery modules 104 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles of a battery module 104, among other examples.

As indicated above, FIG. 1 is provided as an example. Other examples may differ from what is described with regard to FIG. 1.

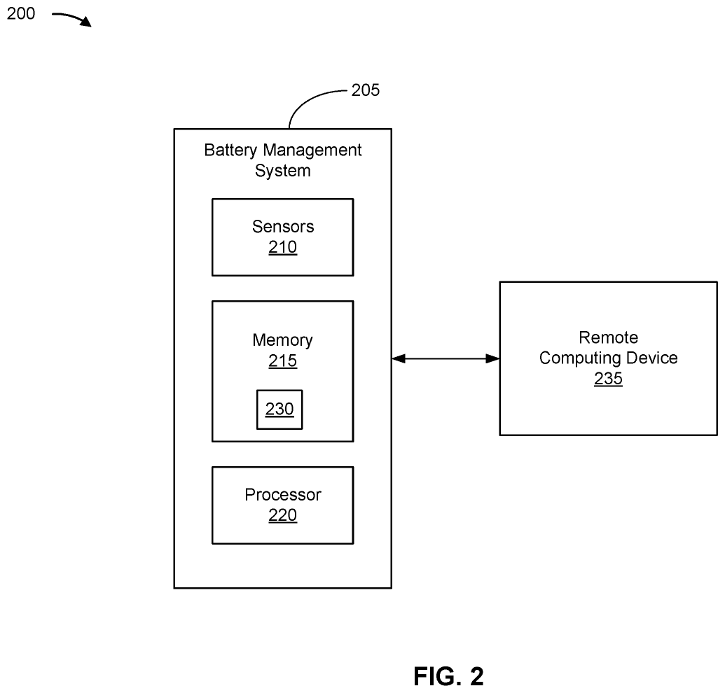

FIG. 2 is a diagram of an example implementation 200 associated with a battery management system (BMS) 205 that includes one or more sensors 210, one or more memories (collectively, the “memory”) 215, and one or more processors (collectively, the “processor”) 220. These devices are described in more detail below.

The sensors 210 may include one or more temperature sensors configured to measure a temperature of one or more battery cells (e.g., battery cells 106). Each temperature sensor may be disposed on a battery cell for measuring a temperature of the battery cell. The sensors 210 may output signals (e.g., cell temperature signals) indicating the temperature of each battery cell (i.e., each temperature signal may be associated with a temperature of a single battery cell), a temperature of a jellyroll of the battery cell, and/or a combination thereof, among other examples.

The memory 215 may store instructions and/or information that can be accessed by the processor 220. For example, the memory 215 may store a thermal model 230, the battery cell temperatures output by the sensors 210, instructions for receiving and/or storing the thermal model as, for example, a state-space file or a functional mock-up unit file, instructions for performing one or more reduced order modeling (ROM) techniques, instructions for determining one or more battery cell temperatures, instructions for determining thermal propagation between battery cells (e.g., cell-to-cell propagation), instructions for measuring the battery cell temperatures, instructions for predicting a thermal runaway event, and/or a combination thereof, among other examples.

The thermal model 230 stored in the memory 215 may represent heat propagation across battery cells. For example, the thermal model 230 may indicate a threshold at which heat from one cell will spread to another cell (i.e., cell-to-cell heat propagation), which may result in a thermal runaway event. The thermal runaway event may include an abusive venting event (e.g., high pressure that causes the release of gases or electrolytes from the battery cell), and the abusive venting event may be caused by cell-to-cell heat propagation.

The processor 220 may be configured to access the information and/or execute instructions stored in the memory 215. For example, the processor 220 may be configured to access the thermal model stored in the memory 215 and apply one or more battery cell temperatures to the thermal model. For example, the processor 220 may be configured to use the thermal model to determine (e.g., estimate, calculate, or predict) thermal propagation between a first battery cell and a second battery cell based on a first temperature associated with the first battery cell and a second temperature associated with the second battery cell. As discussed in greater detail below, the first temperature and the second temperature may be determined in accordance with a ROM technique. The processor 220 may be further configured to determine thermal propagation between one or more battery cells and an external environment in accordance with the thermal model, the ROM technique, and/or a combination thereof, among other examples.

Using the thermal model and the ROM technique, the processor 220 may be configured to determine thermal propagation across different levels of the battery based on estimates of thermal propagation in lower levels of the battery. For example, the processor 220 may be configured to determine thermal propagation across a battery module based on the thermal propagation between battery cells using the thermal model and/or ROM technique. Moreover, using the thermal model and the ROM technique, the processor 220 may be configured to determine thermal propagation across a battery string (e.g., multiple battery modules electrically connected to one another) based on the thermal propagation between battery modules using the thermal model and/or ROM technique. The processor 220 may be further configured to determine thermal propagation across a battery pack based on the thermal propagation between battery strings using the thermal model and/or ROM technique.

The thermal model 230 may be generated using a ROM technique. The ROM technique may be a mathematical model that approximates thermal propagation between battery cells, battery modules, battery strings, and battery packs. The ROM technique may include deriving a simplified model of thermal propagation from a more detailed, high-fidelity model. The simplified model may be derived through techniques such as proper orthogonal decomposition, Krylov subspace methods, or system identification methods. The ROM technique may be performed by the BMS 205 or a remote computing device 235. If performed by the remote computing device 235, the thermal model may be exported and provided to the BMS 205 as a state-space file or functional mock-up unit file.

Accordingly, by estimating thermal propagation across various levels of the battery pack 100 based on the thermal model and ROM technique, the BMS 205 may detect and alert a user of possible thermal runaway events. Moreover, by the BMS 205 detecting a potential thermal runaway event based on temperatures at the battery cell level, the user may be alerted early enough to stop the thermal runaway event from progressing, which could save the battery from malfunctioning and/or failure.

As indicated above, FIG. 2 is provided as an example. Other examples may differ from what is described with regard to FIG. 2.

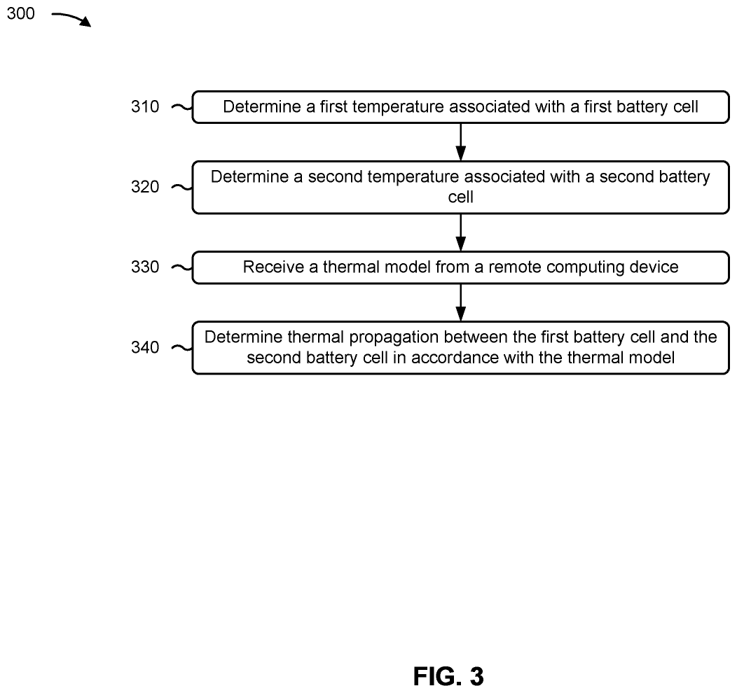

FIG. 3 is a flowchart of an example process 300 associated with determining thermal propagation across components of a battery. One or more process blocks of FIG. 3 may be performed by a BMS (e.g., BMS 205). Additionally, or alternatively, one or more process blocks of FIG. 3 may be performed by another device or a group of devices separate from or including the BMS, such as another device or component that is internal or external to the battery pack 100.

As shown in FIG. 3, process 300 may include determining a first temperature associated with a first battery cell (block 310). For example, the BMS may determine a first temperature associated with a first battery cell, as described above.

As further shown in FIG. 3, process 300 may include determining a second temperature associated with a second battery cell (block 320). For example, the BMS may determine a second temperature associated with a second battery cell, as described above.

As further shown in FIG. 3, process 300 may include receiving a thermal model from a remote computing device (block 330). For example, the BMS may receive a thermal model from a remote computing device, as described above. Receiving the thermal model may include receiving a state-space file in accordance with the thermal propagation between the first battery cell and the second battery cell. Receiving the thermal model may include receiving a functional mock-up unit file in accordance with the thermal propagation between the first battery cell and the second battery cell.

As further shown in FIG. 3, process 300 may include determining thermal propagation between the first battery cell and the second battery cell in accordance with the thermal model (block 340). For example, the BMS may determine thermal propagation between the first battery cell and the second battery cell in accordance with the thermal model, as described above.

The process 300 may include determining thermal propagation between the first battery cell and an external environment in accordance with the thermal model. The process 300 may include determining thermal propagation between the second battery cell and an external environment in accordance with the thermal model. The process 300 may include determining thermal propagation across a battery module in accordance with the thermal model and the thermal propagation between the first battery cell and the second battery cell. The process 300 may include determining thermal propagation across a battery pack in accordance with the thermal model and the thermal propagation across the battery module. The process 300 may include determining thermal propagation across a battery string in accordance with the thermal model and the thermal propagation across the battery module. The process 300 may include determining thermal propagation across a battery plant in accordance with the thermal model and the thermal propagation across the battery module.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### INDUSTRIAL APPLICABILITY

The BMS described herein may be used to predict thermal runaway events for a battery pack based on temperature measurements at the level of the battery cell. By the BMS doing so, the thermal runaway event may be detected sooner, giving a user more time to intervene and possibly prevent the thermal runaway event and salvage one or more battery modules in the battery pack. Further, because the BMS applies a thermal model generated using a ROM technique, the computational load on the BMS is reduced, allowing for faster determinations and lower power consumption.

What is claimed is:

1. A battery management system, comprising:
one or more memories; and
one or more processors, communicatively coupled to the one or more memories, configured to:
receive a thermal model in accordance with a first temperature associated with a first battery cell and a second temperature associated with a second battery cell; and
determine thermal propagation between the first battery cell and the second battery cell in accordance with the thermal model.

2. The battery management system of claim 1, wherein the one or more processors are further configured to:
determine thermal propagation between the first battery cell and an external environment in accordance with the thermal model; and
determine thermal propagation between the second battery cell and the external environment in accordance with the thermal model.

3. The battery management system of claim 1, wherein the one or more processors are further configured to receive the thermal model as a state-space file.

4. The battery management system of claim 1, wherein the one or more processors are further configured to receive the thermal model as a functional mock-up unit file.

5. The battery management system of claim 1, wherein the one or more processors are further configured to determine thermal propagation across a battery module in accordance with the thermal model and the thermal propagation between the first battery cell and the second battery cell.

6. The battery management system of claim 5, wherein the one or more processors are further configured to determine thermal propagation across a battery string in accordance with the thermal model and the thermal propagation across the battery module.

7. The battery management system of claim 6, wherein the one or more processors are further configured to determine thermal propagation across a battery pack in accordance with the thermal model and the thermal propagation across the battery string.

8. The battery management system of claim 7, wherein the one or more processors are further configured to determine thermal propagation across a battery plant in accordance with the thermal model and the thermal propagation across the battery string.

9. A method, comprising:
determining a first temperature associated with a first battery cell;
determining a second temperature associated with a second battery cell;
receiving a thermal model from a remote computing device; and
determining thermal propagation between the first battery cell and the second battery cell in accordance with the thermal model.

10. The method of claim 9, further comprising determining thermal propagation between the first battery cell and an external environment in accordance with the thermal model.

11. The method of claim 9, further comprising determining thermal propagation between the second battery cell and an external environment in accordance with the thermal model.

12. The method of claim 9, wherein receiving the thermal model includes receiving a state-space file in accordance with the thermal propagation between the first battery cell and the second battery cell.

13. The method of claim 9, wherein receiving the thermal model includes receiving a functional mock-up unit file in accordance with the thermal propagation between the first battery cell and the second battery cell.

14. The method of claim 9, further comprising determining thermal propagation across a battery module in accordance with the thermal model and the thermal propagation between the first battery cell and the second battery cell.

15. The method of claim 14, further comprising determining thermal propagation across a battery pack in accordance with the thermal model and the thermal propagation across the battery module.

16. The method of claim 14, further comprising determining thermal propagation across a battery string in accordance with the thermal model and the thermal propagation across the battery module.

17. The method of claim 14, further comprising determining thermal propagation across a battery plant in accordance with the thermal model and the thermal propagation across the battery module.

18. A machine, comprising:
a battery module having a plurality of battery cells including a first battery cell and a second battery cell; and
a battery management system configured to:
receive a thermal model; and
determine thermal propagation between the first battery cell and the second battery cell in accordance with the thermal model.

19. The machine of claim 18, wherein the battery management system is further configured to:
determine thermal propagation between the first battery cell and an external environment in accordance with the thermal model; and
determine thermal propagation between a second battery cell and the external environment in accordance with the thermal model.

20. The machine of claim 18, wherein the battery management system is further configured to receive the thermal model as one or more of a state-space file or a functional mock-up unit file.
